(19) United States
(12) Patent Application Publication
(10) Pub. No.: US 2004/0262082 A1
(43) Pub. Date: Dec. 30, 2004

(54) Access step

(76) Inventor: Gayle D. Bay, Centreville, VA (US)

Correspondence Address: Gayle D. Bay, 14427 Glencrest Circle, Centreville, VA, 20120, US

(21) Appl. No.: 10/607,308

(22) Filed: Jun. 27, 2003

(51) Int. Cl. E06C 1/00

(52) U.S. Cl. 182/35

(57) ABSTRACT

An access step that moves from beneath a cabinet. The access step includes a kick-plate actuated mechanism that selectively retains the access step beneath the cabinet when not in use, but that forces the access step away from its retention position when an impact is applied to the kick-plate. The access step includes lights. The access step also includes an extendable second step that a user can extend when higher access is required. Friction elements on the step prevent a user's foot from slipping. The attachment mechanism can move the access step on rails away from the cabinet or it can rotate the access step away from the cabinet on a pivot. The access step includes rollers that retract into recess when a user steps on the access step. The access step further includes an anti-marring element that engages the floor when weight is placed on the access step.

### FIELD OF THE INVENTION

This invention relates to steps used for accessing items over cabinets, appliances, and shelves.

### BACKGROUND OF THE INVENTION

Ladders are often used to reach items located over kitchen and bathroom cabinets. For example, shorter adults and children often require assistance in reaching cans, dishes, and soap that are placed in cabinets over stoves, counter tops, and sinks. Indeed, millions of homes in the United States require access ladders.

While access ladders are highly useful, they can and do cause serious accidents around the home, for example falling. Simply leaning too far in one direction will cause many ladders to fall over, possibly resulting in serious injuries or even death. Other problems with conventional ladders include their unsightly clutter and tripping hazards. Often, an un-used ladder simply remains where it was used last, creating an unsightly hazard. Even foldable ladders take up valuable storage space. Furthermore, conventional access ladders are often inconvenient to use, particularly for children.

Another danger with conventional ladders is that users can miss steps because of poor lighting. Missteps can and do cause falling accidents and serious injury.

There have been numerous attempts to address the limitation of conventional access ladders. For example, foldable step ladders have been stored under kitchen cabinets, reference U.S. Pat. No. 3,481,429 to Gaede (19116), or inside cabinet doors, reference U.S. Pat. No. 3,136,386 to Horvath, et al. (1964) and U.S. Pat. No. 5,085,308 to E. C. Guirlinger (1992). Foldable step ladders also have been mounted on the outside of cabinet doors, reference U.S. Pat. Nos. 2,581,488 to Keltner, et al. (1952), U.S. Pat. No. 3,030,166 to Richards, et al. (1962), and U.S. Pat. No. 3,833,089 to Backwell (1974), or under lower cabinet shelves, reference U.S. Pat. No. 2,801,894 to MacInnes (19114) and U.S. Pat. No. 4,846,304 to Rasmussen (1989). Also, reference U.S. Pat. No. 2,881,040 to Hartridge (1959) and U.S. Pat. No. 4,135,604 to Ryan (1979) for other approaches.

However, while generally beneficial, the foregoing teachings have not been totally successful. Therefore, a new access ladder, beneficially having both ease of use and safety, for reaching items would be beneficial. Even more beneficial would be such a device that could be easily stored when not in use and that is immediately available when needed. Also beneficial would be lighted steps that enable a user to clearly see where they are stepping.

### BRIEF SUMMARY OF THE INVENTION

The following is provided to facilitate an understanding of some of the innovative features unique to the present invention, and is not intended to be a full description. A full appreciation of the various aspects of the invention can be gained by taking the entire specification, claims, drawings, and abstract as a whole.

The present invention provides for access steps that are easily used and immediately available for accessing items over counter tops, sinks, stoves, and other obstructions. Furthermore, the present invention provides for access steps that are difficult or impossible to turn over, thus reducing accidents that could cause serious injury. Beneficially the access steps are also lighted to assist a user in dark locations or at night, thus reducing accidents even further. Preferably the step lights are activated by a light sensitive element such that the lights come on automatically in the dark. The access steps are implemented such that they reduce or eliminate clutter and are easy to use and store. Beneficially, an access step includes a first step and an extendable second step. Beneficially the second step includes finger holes or a handle to enable a user to extend the second step when higher access is required. The second step includes a latch mechanism that is engaged when the second step is extended so as to support a user's weight. The first and second steps are lighted and include a friction member on their step surfaces to prevent a user's foot from slipping.

Access steps in accord with the present invention include a spring-loaded kick-plate mechanism that snaps an access step from below a cabinet or other structure where it is stored. Beneficially, the extendable second step is also spring-loaded such that it can spring upward when its use is required. The first step includes at least one spring-biased roller that enables easy opening of the access step from under the cabinet. Also beneficially, the first step includes an anti-marring element such as a felt or rubber pad that engages the floor when weight is placed on the access step. The anti-marring element prevents damage to the floor and increases friction contact with the floor, further improving safety.

The access step is preferably attached to a cabinet. One attachment mechanism includes rails that enable the access step to slide out from under a cabinet. Another type of attachment mechanism pivots the access step from a predetermined position under a cabinet. In either case, the attachment mechanism includes a latch feature that retains the access step in the predetermined position under the cabinet until released. Beneficially the release is activated by a kick plate.

The novel features of the present invention will become apparent to those of skill in the art upon examination of the following detailed description of the invention, or can be learned by practice of the present invention. It should be understood, however, that the detailed description of the invention and the specific examples presented, while indicating certain embodiments of the present invention, are provided for illustration purposes only because various changes and modifications within the spirit and scope of the invention will become apparent to those of skill in the art from the detailed description of the invention, the claims that follow, and the drawings.

### BRIEF DESCRIPTION OF THE DRAWINGS

The accompanying figures, in which like reference numerals refer to identical or functionally-similar elements throughout the separate views, and which are incorporated into and form part of the specification, further illustrate the present invention and, together with the detailed description of the invention, serve to explain the principles of the present invention.

FIG. 1 illustrates a top down view of a partially opened first embodiment access step extending from beneath a cabinet;

FIG. 2 illustrates a schematic side views of the first embodiment access step beneath a cabinet;

FIG. 3 illustrates top down views of a second embodiment access step in place beneath a cabinet;

FIG. 4 is a perspective view of the second embodiment; and

FIG. 5 illustrates a side view of an extended second access step.

### DETAILED DESCRIPTION OF THE INVENTION

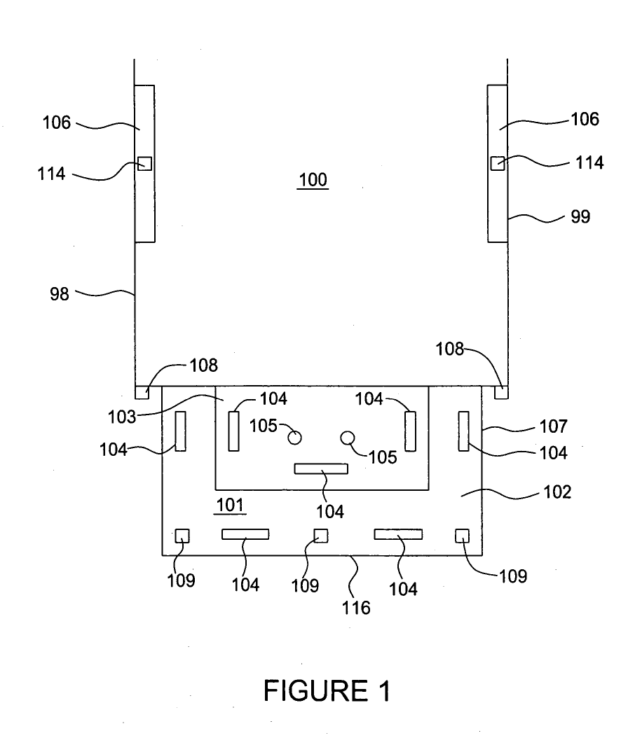

The present invention relates to access steps that are used with things such as cabinets and appliances. In particular, the present invention relates to access steps having a first step and a second step that selectively extends above the first step. For example, FIG. 1 illustrates a top-down view of a cabinet 98 having a countertop 100. Below the cabinet 98 is an access step 101 that includes a first step 102 and a second step 103 that can extend from the first step 102. To assist a user in the dark, the top of the first step 102 and the top of the second step 103 can be made at least partially transparent to enable lights 104 to illuminate the access step 101, or such lights 104 can be placed in recesses in the tops of the first step 102 and the second step 103.

As noted, the second step 103 can selectively extend from the first step 102. To assist doing so the second step 103 includes finger holes 105, or some other type of grip or handle, that enables a user to extend the second step 103 from the first step 102.

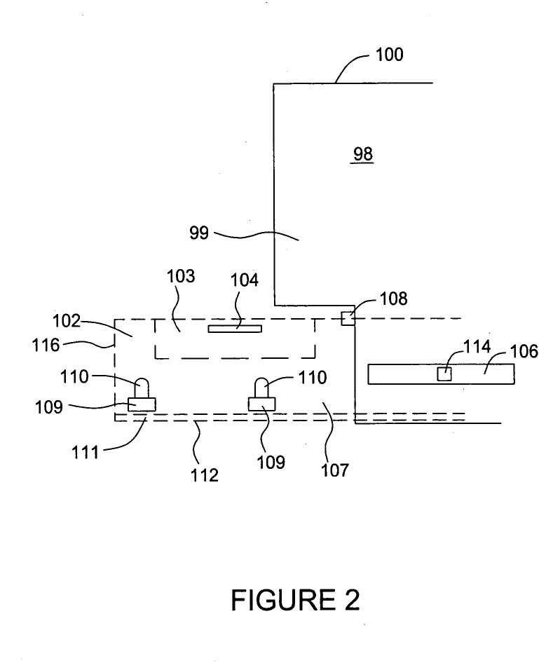

Referring now to FIGS. 1 and 2, the access step 101 beneficially slides from beneath the cabinet 98 on rails 106 that are attached to a wall 99 of the cabinet 98 and that connect a vertical wall 107 of the first step 102 to the cabinet 98. At the bottom 111 of the first step 102 are rollers 109 that are biased downward by springs 110. When no weight is placed on the access step 101 the rollers 109 enable the access step 101 to easily move across a floor (not shown). However, when sufficient weight is placed on the access step 101 the springs 110 compress and the rollers 109 are pushed into recesses 314 below the first step 102. When sufficient weight is placed on the access step 101 the bottom 111 of the first step rests on an anti-mar element 112 such as felt.

The front of the first step 102 includes a kick-plate 116. When the access step 101 is in position under the cabinet 98 latch mechanisms 114 in the rails 106 close, preventing the access step 101 from opening. Furthermore, when the access step 101 is under the cabinet 98 a spring-biased mechanism 108 is compressed. Upon sufficient impact on the kick-plate 116 the latch mechanisms 114 release, which lets the spring-biased mechanisms 108 force the access step 101 away from its position under the cabinet 98. When a user is done using the access step 101 the user pushes the access step 101 back under the cabinet until the latch mechanisms 114 engage, again preventing the access step 101 from extending. Such kick-plate mechanisms are well known to those skilled in the applicable arts.

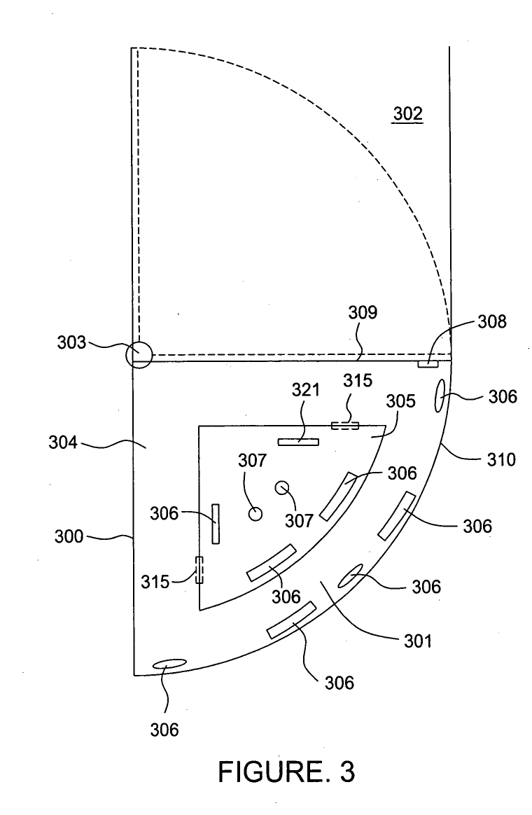

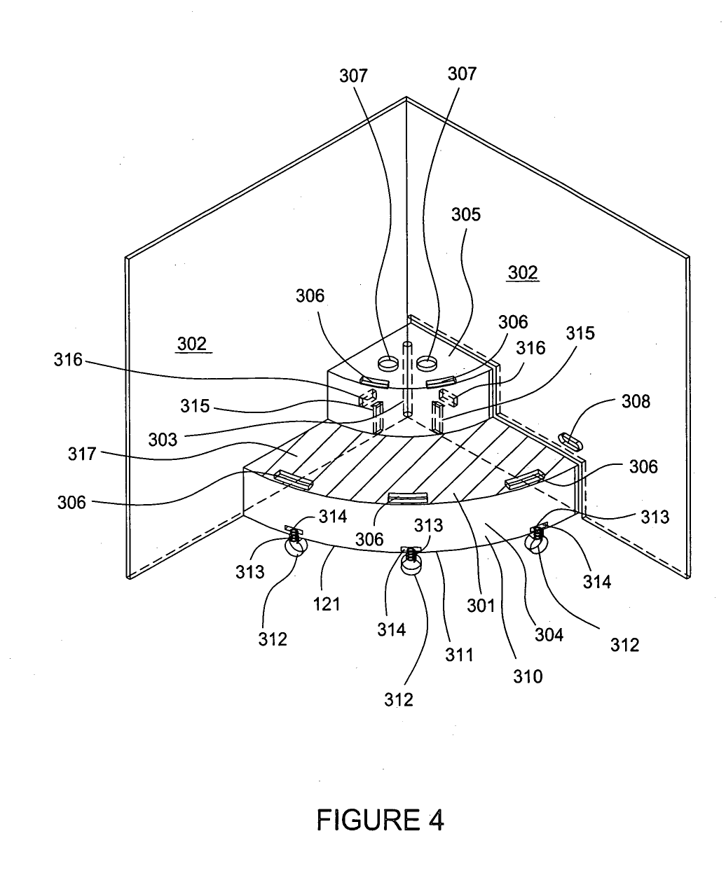

While FIGS. 1 and 2 illustrate a useful embodiment of the invention, an alternative embodiment is illustrated in FIGS. 3 and 4. That alternative embodiment is a kick-plate 300 activated access step 301 that pivots from under a cabinet 302 on a pivot 303. The access step 301 includes a first step 304 and a second step 305 that is extendable from the first step 304. To assist a user in the dark, the tops of the first step 304 and the second step 305 can be at least partially transparent to enable lights 306 to illuminate the access step 301, or such lights 306 can be placed in recesses in the tops of the first and second steps 304, 305.

As noted the second step 305 can selectively extend from the first step 304. To assist doing so the second step 305 includes finger holes 307, or some other type of grip or handle, that enables a user to extend the second step 305 from the first step 304.

The access step 301 beneficially pivots from beneath the cabinet 300 on the pivot 303 when the kick-plate 300 is impacted sufficiently. The access step is beneficially held in place by a spring latch mechanism 308 that is attached to a wall 309 of the cabinet 300. An end of the spring latch mechanism 308 connects to a vertical wall 310 of the first step 304. Attached to the bottom 311 of the first step 304 are rollers 312 that are biased downward by springs 313. When sufficient impact is applied to the kick-plate 300 the spring latch mechanism 308 releases, which enables the spring latch mechanism 308 to force the access step 301 from beneath the cabinet 300. When no weight is placed on the access step 301 the rollers 312 enable the access step 301 to easily swing across a floor (not shown). However, when sufficient weight is placed on the access step 301 the springs 313 compress and the rollers 312 are pushed into recesses 314 at the bottom 311 of the first step 304. When sufficient weight is placed on the access step 301 the bottom 311 of the first step 304 rests on an anti-mar element (112, see FIGS. 1 and 2) such as felt.

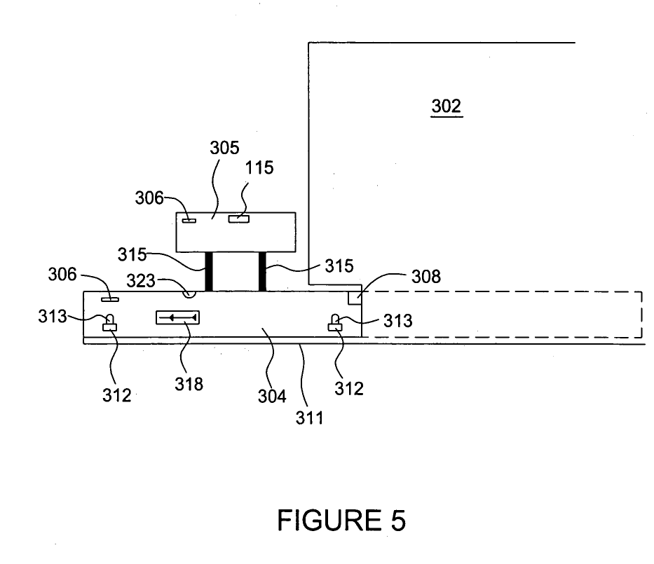

The embodiments illustrated in FIGS. 1-4 have been described as having an extendable second step. To that end, both embodiments include a weight-bearing support that supports the second step. For example, FIG. 5 illustrates a spring loaded, weight-bearing support 315 that retains the second step 305 in position over the first step 304. Such a weight-bearing support 315 can include any of a number of release mechanisms that enable the second step 305 to return to its position within the first step 304 when the user is finished using the second step 305. When extended the supports 315 are locked in position to support a user's weight. When the second step 305 is not extended the supports are compressed and latched in a compressed position to prevent the second step 305 from extending. FIG. 5 further illustrates a plunger 323 that releases the second step 305 from its compressed position, which enables the second step to pop-up slightly.

To prevent a user's foot from slipping from the access steps 101 and 301, it is beneficial to include a non-slip feature 317 to the tops of the various steps. A non-skid paint, rubber strips, or grooves are examples of such a non-slip feature.

Additionally, the lights 104 and 306 can be implemented to turn on automatically when the step is used in the dark. To that end, an optically sensitive switch 318 is included to automatically turn on the lights. The optically sensitive switch 318 may include a photo-diode or similar semiconductor device that senses light.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different be defined by the claims appended hereto, giving full cognizance to equivalents in all respects.

What I claim is:

1. An access step comprising:
a first step having vertical walls, each having a bottom and a top, and an upper surface over the vertical walls for forming a first step;
an assembly including an attachment mechanism connected to at least one vertical wall for mounting the first step under a cabinet, said assembly further including a spring latch mechanism that retains the first step in a predetermined position when the spring latch mechanism is latched and forces the first step away from the predetermined position when the spring mechanism is released;
a kick-plate for releasing the spring latch mechanism when an impact is applied to the kick-plate.

2. An access step according to claim 1, wherein the bottom of the first step includes, a recess for retaining a roller.

3. An access step according to claim 2, further including a spring that biases the roller such that the first step rolls over a floor when weight is not applied to the first step, and such that the roller moves into the recess when weight sufficient to compress the spring is on the first step.

4. An access step according to claim 3, further including an anti-marring member attached to a bottom for supporting the first step when the roller is in the recess.

5. An access step according to claim 1, wherein the upper surface includes a friction feature.

6. An access step according to claim 1, wherein the upper surface includes illumination lights.

7. An access step according to claim 6, wherein the illumination lights illuminate automatically when the access step is used in the dark.

8. An access step according to claim 6, wherein the upper surface includes a transparent section, and wherein the illumination lights are mounted below the transparent section.

9. An access step according to claim 6, further including a light sensitive element for automatically turning on the illumination lights when the access step is in the dark.

10. An access step according to claim 1, further including a second step that extends up from said first step.

11. An access step according to claim 10, wherein the second step extends from an opening in the first step.

12. An access step according to claim 11, wherein the second step includes a step member having means for enabling a user to extend the second step from the first step.

13. An access step according to claim 10, further including a latch mechanism for retaining the second step in its extended position and such that the second step is capable of supporting a user.

14. A cabinet assembly comprising:
an enclosure having sidewalls and a base;
an attachment mechanism;
a first step mounted beneath the enclosure by the attachment mechanism, the first step having vertical walls, each having a bottom and a top, and an upper surface over the vertical walls for forming a first step;
a spring latch mechanism that retains the first step in a predetermined position when the spring latch mechanism is latched and forces the first step away from the predetermined position when the spring latch mechanism is released; and
a kick-plate;
wherein the spring latch mechanism retains the first step in a predetermined position under the cabinet when the spring-load attachment mechanism is latched, and wherein the spring latch mechanism forces the first step away from the predetermined position when the attachment mechanism is released; and
wherein the kick-plate releases the spring latch when an impact is applied to the kick-plate.

15. A cabinet assembly according to claim 14, wherein the bottom of the first step includes a recess retaining a roller.

16. A cabinet assembly according to claim 15, further including a spring that biases a roller downward such that the first step rolls over a floor if weight is not applied to the first step, and wherein the roller moves into the recess when additional weight sufficient to compress the spring is applied to the first step.

17. A cabinet assembly according to claim 14, further including an anti-marring member attached to the bottom for supporting the first step when the roller is in the recess.

18. A cabinet assembly according to claim 14, wherein the first step pivots on the attachment mechanism.

19. A cabinet assembly according to claim 14, wherein the upper surface includes illumination lights.

20. A cabinet assembly according to claim 14, further including a second step that extends up from said first step.
